(19) United States
(12) Patent Application Publication
(10) Pub. No.: US 2005/0153819 A1
(43) Pub. Date: Jul. 14, 2005

(54) Heatable roll

(75) Inventor: Eugen Schnyder, Waltenschwil (CH)

Correspondence Address: GREENBLUM & BERNSTEIN, P.L.C., 1950 ROLAND CLARKE PLACE, RESTON, VA, 20191, US

(73) Assignee: VOITH PAPER PATENT GmbH, Heidenheim (DE)

(21) Appl. No.: 11/022,881

(22) Filed: Dec. 28, 2004

(30) Foreign Application Priority Data
Jan. 14, 2004 (DE) 10 2004 002 003.5

(51) Int. Cl. D21G 1/02; B29C 43/46

(52) U.S. Cl. 492/6; 492/46

(57) ABSTRACT

A heatable roll for thermal treatment of material webs that includes a supporting system and a roll shell revolving around the supporting system. Moreover, the roll shell comprises a heatable outer shell and a thermally insulating inner shell, and the thermally insulating inner shell is arranged between the outer shell and the supporting system. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 10 2004 002 003.5, filed on Jan. 14, 2004, the disclosure of which is expressly incorporated by reference herein in its entirety.

### BACKGROUND OF THE INVENTION

1. Field of the Invention

The invention relates to a heatable roll, in particular for the thermal treatment of material webs, having a roll shell revolving around a supporting system.

For instance, during the thermal consolidation of nonwoven materials or similar materials, during specific textile finishing processes, such as in particular during the embossing of textiles and so on, the relevant material web is led through a nip formed between two heated rolls. Here, under certain circumstances, it may be expedient if at least one of the two rolls is designed as a controlled deflection roll. As a rule, the rolls are heated by a heat exchange medium, in the case of controlled deflection rolls the heat exchange medium as a rule being used simultaneously as a supporting and lubricating material. Rolls of this type have the disadvantage that very complicated peripheral equipment is necessary. Moreover, the heat energy which can be conducted through the shell is limited. At higher web speeds, sealing the rolls is a problem.

2. Discussion of Background Information

A roll construction has already been proposed in which a double shell is used, in order to encapsulate the oil when changing the outer shell. The outer shell can therefore simply be pulled off and pushed on again. The inner cover is designed in such a way that, in the unpressurized state, there is a small clearance between the inner and outer shells which, in operation, is taken up by means of a slightly increased internal roll pressure, which is associated with slight inflation of the inner shell (compare with, for example, DE 40 26 007 A1).

### SUMMARY OF THE INVENTION

The invention is based on providing an improved heatable roll of the aforementioned type in which the outer shell can be heated separately from the supporting system and/or the roll core.

According to the invention, this is achieved in that the roll shell includes a heatable outer shell and a thermally insulating inner shell arranged between this outer shell and the supporting system.

On account of this design, the outer shell can now be heated separately from the supporting system, preferably only the outer shell is being heated, that is to say the supporting system and/or the roll core remains unheated.

In a preferred practical embodiment, the roll is designed as a controlled deflection or deflection compensating roll, whose supporting system comprises a yoke which passes axially through the roll shell and is fixed against rotation, and a plurality of supporting elements which follow one another in the axial direction and are preferably hydraulic. In this case, the thermally insulating inner shell can preferably be acted on directly by the supporting elements.

The thermally insulating inner shell preferably includes a temperature-resistance plastic. In this case, this thermally insulating inner shell can include PEEK or any thermoplastic resins of the polyetheretherketone type, for example. It may also be expedient to provide this shell with a suitable tribological functional layer, for example a polytetrafluoroethylene layer such as a Teflon layer, in order to prevent wear, which could otherwise occur because of the relative movements occurring as a result of the concept. The same is true of the outer shell.

The roll can in particular be designed as a self-adjusting F roll. In principle, however, a design as a concentrically guided K roll, for example, is also conceivable.

Also advantageous in particular is a design of the thermally insulating inner shell in which the latter is used simultaneously as a seal with respect to the guide mounting.

In the unheated state of the roll and, if appropriate, with the supporting elements not activated, there is preferably a clearance between the heatable outer shell and the thermally insulating inner shell. During operation, this clearance is advantageously taken up by appropriate thermal expansion of the inner shell and/or by the internal pressure.

The thermally insulating inner shell can be grooved on or provided with at least one notch in its outer circumference. Alternatively or additionally, the heatable outer shell can be grooved or provided with at least one notch on its inner circumference. In order to cool the roll down, cold air can advantageously be blown in the grooved or notched region between the outer shell and inner shell.

The heatable outer shell preferably includes steel.

According to a preferred practical embodiment of the roll according to the invention, the heatable outer shell can be pushed onto the thermally insulating inner shell.

The outer shell can preferably be heated from outside.

According to an expedient practical embodiment, the outer shell can be heated inductively, in particular from outside.

In the case of an F roll, the induction loop can preferably be moved together with a slotted F guide, so that a constant distance from the outer shell can be maintained.

The thermally insulating inner shell preferably has a lower thickness than the heatable outer shell.

Thus, the thickness of the thermally insulating inner shell can lie, for example, in a range from about 2 to about 15 mm and in particular in a range from about 8 to about 15 mm. The thermally insulating inner shell expediently has an average thickness of about 10 mm.

The heatable outer shell can be provided with a rubber covering. In addition to rubber, suitable plastics are also conceivable.

If required, a cantilever can be provided in order to suspend the roll in the framing.

It is also advantageous in particular if, on the operating side, a bearing is provided for exposing the outer shell to be pulled off.

The heatable outer shell and the thermally insulating inner shell can, for example, also be adhesively bonded to each other. Appropriately, heat-resistant adhesives are already on the market.

The roll according to the invention can be used with particular advantage during the production of nonwovens or similar materials and, in this case, in particular for the consolidation of the relevant materials. Furthermore, it can also be applied with advantage in particular to specific textile finishing processes such as in particular to the embossing of textiles and so on.

However, the roll according to the invention can also be used with advantage, for example, as a respective opposing roll in a NipcoFlex calender.

The roll according to the invention permits the use of simple, tried, and tested technology to compensate for deflection and for heating of the roll shell separately from the supporting system. The supporting system can therefore be run cold or relatively cold. To a greater or lesser extent, any NIPCO roll, as it is known, can be expanded to form a heatable roll. In particular, in the case of wide product webs which are run at high web speeds, this is of considerable advantage. In addition, the heat energy can be applied directly from the outside and considerably higher energy densities can be achieved.

One aspect of the invention includes a heatable roll for thermal treatment of material webs that includes a supporting system and a roll shell revolving around the supporting system. Moreover, the roll shell includes a heatable outer shell and a thermally insulating inner shell, and the thermally insulating inner shell is arranged between the outer shell and the supporting system.

In a further aspect of the invention the outer shell can be structured and arranged to be separately heatable from the supporting system, and the supporting system can be structured and arranged to remain unheated when the outer shell is heated. Moreover, the roll can be structured and arranged as a controlled deflection roll and the supporting system can include a yoke which axially passes through the roll shell and is fixed against rotation, and a plurality of supporting elements which follow one another in an axial direction. Furthermore, the supporting elements can be arranged to act directly on the thermally insulating inner shell. Additionally, the thermally insulating inner shell can include a temperature-resistant plastic. Furthermore, the thermally insulating inner shell can include PEEK. Additionally, one of the heatable outer shell and the thermally insulating inner shell can have one of a tribological functional layer and a polytetrafluoroethylene layer. Moreover, the roll can be structured and arranged as a self-adjusting F roll. Furthermore, the roll can be structured and arranged as a concentrically guided K roll. Additionally, the thermally insulating inner shell can be structured and arranged to be simultaneously used as a seal with respect to a guide mounting. Additionally, the roll shell can be structured to have a clearance between the heatable outer shell and the thermally insulating inner shell when unheated and when supporting elements of the support system are not activated. Moreover, a clearance can be reduced during operation by at least one of thermal expansion of the thermally insulating inner shell and internal pressure. Furthermore, the thermally insulating inner shell can be at least one of grooved and notched on an outer circumference. Moreover, the heatable outer shell can be at least one of grooved and notched on an inner circumference. Additionally, the roll can have at least one of a grooved and notched region between the outer shell and the inner shell structured and arranged to receive blown air for cooling. Furthermore, the heatable outer shell can include steel. Moreover, the heatable outer shell can be structured and arranged to be pushed onto the thermally insulating inner shell. Additionally, the outer shell can be heatable from the outside. Moreover the outer shell can be inductively heatable. Furthermore, the roll can be structured and arranged as an F roll, wherein an induction loop can be moved with a slotted F guide. Moreover, the thermally insulating inner shell can be thinner than the heatable outer shell. Additionally, the thickness of the thermally insulating inner shell can range from about 8 to about 15 mm. Furthermore, the thermally insulating inner shell can have an average thickness of about 10 mm. Moreover, the heatable outer shell can be configured with one of a rubber covering and a plastic cover. Additionally, the roll can include a cantilever structured and arranged to suspend the roll in a framing. Moreover, the roll can include a bearing structured and arranged to expose the outer shell to be pulled off on an operating side. Additionally, the heatable outer shell can be adhesively bonded to the thermally insulating inner shell. Moreover, the present invention can include a method of producing a nonwoven material using the roll noted above. Furthermore, the present invention can include a method of consolidating a nonwoven material using the roll noted above. Additionally, the present invention can include a method of embossing a nonwoven material using the roll noted above. Moreover the above-noted roll can be used in combination with a NipcoFlex calender and the roll can be structured and arranged as an opposing roll.

Another aspect of the invention includes a heatable roll for thermal treatment of material webs that includes a thermally insulating inner shell arranged on a supporting system and a heatable outer shell arranged over the thermally insulating inner shell.

Yet another aspect of the invention includes a process for thermal treatment of material webs, the roll having a supporting system and a roll shell, the roll shell composed of an outer shell and an insulating inner shell. The process includes heating the outer shell of the roll shell, while the supporting system is thermally insulated from the heating.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic longitudinal sectional illustration of an exemplary embodiment of the heatable roll according to the invention;

FIG. 2 shows a schematic cross-sectional illustration of the roll according to FIG. 1, sectioned along the line A-A in FIG. 1; and

FIGS. 3, 4, 5, 6, and 7 show various graphs relating to the radial temperature distribution over the double shell of the roll for different surface temperatures, different wall thicknesses of the thermally insulating inner shell and different heat energies.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

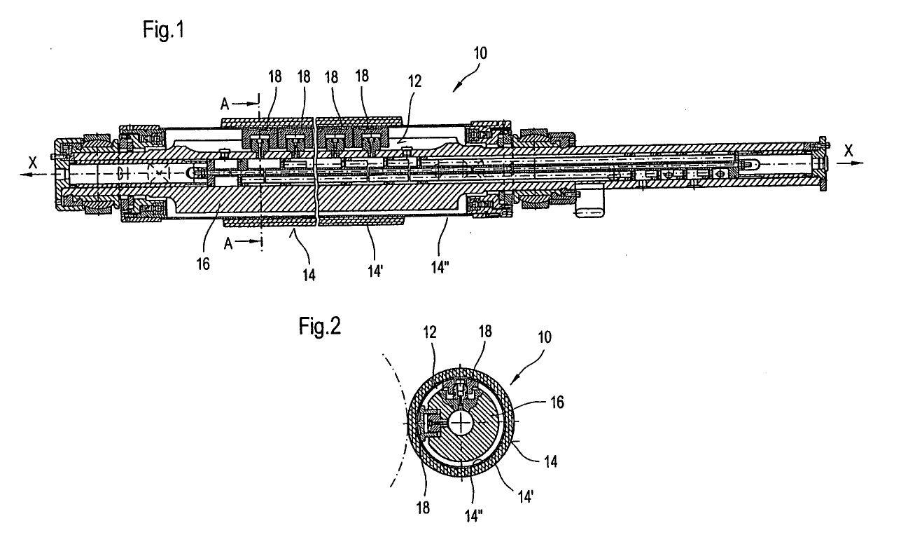

FIGS. 1 and 2 show in a schematic longitudinal sectional illustration and in a schematic cross-sectional illustration an exemplary embodiment of a heatable roll 10 according to the invention which, in particular, can be used for the thermal treatment of material webs.

The roll shell 14 of this heatable roll 10, revolving around a supporting system 12, comprises a heatable outer shell 14′ and a thermally insulating inner shell 14″ arranged between said outer shell 14′ and the supporting system 12.

The outer shell 14′ can thus be heated separately from the supporting system 12, it preferably being possible for only the outer shell 14′ to be heated, that is to say the supporting system 12 remains unheated and is operated cold or relatively cold.

In the present case, the roll 10 is designed as a controlled deflection roll, whose supporting system 12 comprises a yoke 16 which passes axially through the roll shell 14 and is fixed against rotation and also a plurality of supporting elements 18 which follow one another in the axial direction X. The supporting elements are preferably hydraulic. In the present case, for example, two rows of supporting elements are provided (compare with FIG. 2).

As can be seen from FIGS. 1 and 2, the thermally insulating inner shell 14″ is acted on directly by the supporting elements 18.

The thermally insulating inner shell 14″ preferably includes a temperature-resistant plastic, for example, of PEEK or the like.

In the present case, the roll 10 is designed as a concentrically guided K roll. However, a design as a self-adjusting F roll is also possible. In this case, the thermally insulating inner shell 14″ can also be designed in such a way that it is simultaneously used as a seal with respect to the guide mounting.

In the unheated state of the roll 10 and when the supporting elements 18 are not activated, there can be a clearance between the heatable outer shell 14′ and the thermally insulating inner shell 14″. This clearance is taken up in operation by corresponding thermal expansion of the inner shell 14″ and/or by the internal pressure. In the present case, the clearance is primarily taken up by the thermal expansion of the inner shell. However, the outer shell 14′ and the inner shell 14″ can also be adhesively bonded to each other.

The outer circumference of the thermally insulating inner shell 14″ and/or the inner circumference of the heatable outer shell 14′ can be grooved or provided with at least one notch. In order to cool down the roll 10, cold air can then be blown through the grooved or notched region between outer shell 14′ and inner shell 14″.

The heatable outer shell 14′, preferably consisting of steel, can simply be pushed onto the thermally insulating inner shell 14″.

The outer shell 14′ can preferably be heated from outside. This outer shell 14′ is advantageously heated inductively. In the case of an F roll, an induction loop can be moved together with the slotted F guide, so that a constant distance from the outer shell 14′ to be heated is ensured.

As can be seen from FIGS. 1 and 2, the thermally insulating inner shell 14″ has a considerably smaller thickness than the heatable outer shell 14′. In this case, the thickness of the thermally insulating inner shell 14″ can, for example, lie in a range from about 2 to about 15 mm and in particular in a range from about 8 to about 15 mm. The thermally insulating inner shell 14″ preferably has an average thickness of about 10 mm.

The heatable outer shell 14′ can be provided with a rubber covering. In addition to rubber, suitable plastics are also conceivable.

In specific cases, it may be advantages if a cantilever is provided in order to suspend the roll 10 in the framing. However, a cantilever of this type is not imperative.

On the operating side, a bearing is provided in order to expose the outer shell 14′ to be pulled off.

The roll can be used with particular advantage during the production of nonwovens or similar materials and, in this case, in particular for the consolidation of the relevant materials. Furthermore, it can also be applied with advantage in particular to specific textile finishing processes such as, in particular, to the embossing of textiles and so on. A use of the roll 10 in particular as a respective opposing roll of a NipcoFlex calender is also of advantage.

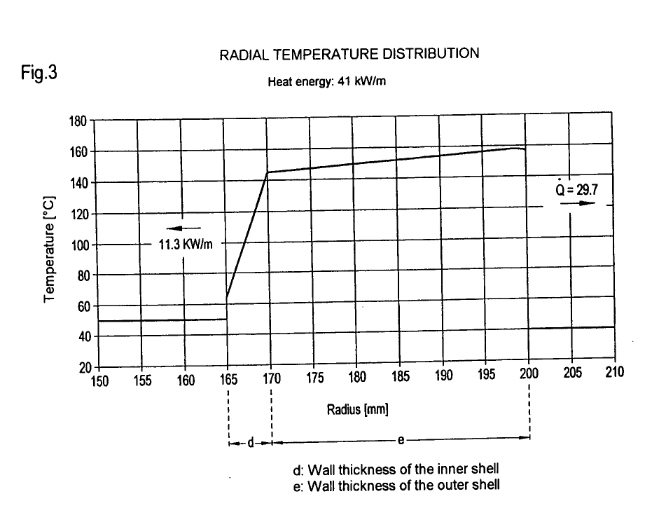

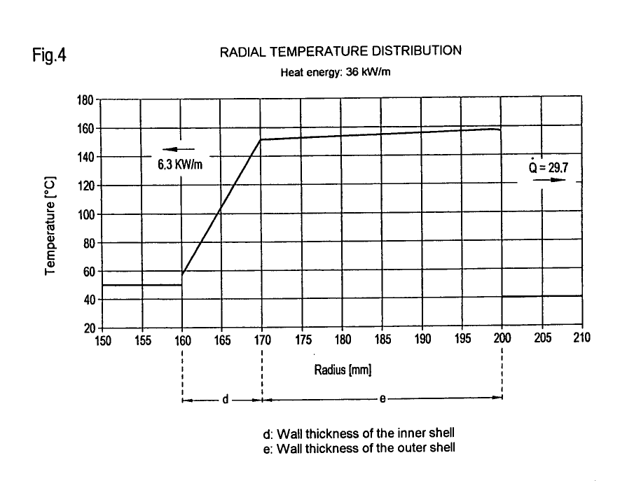

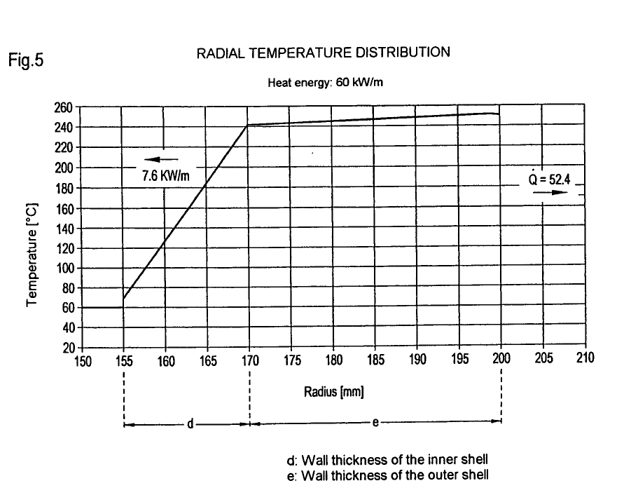

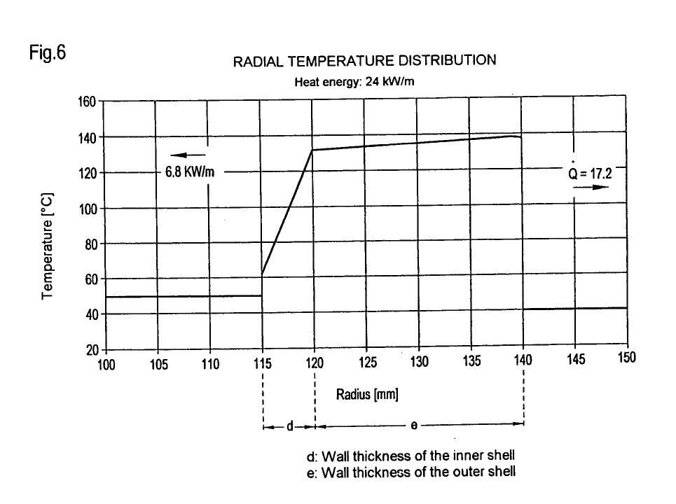

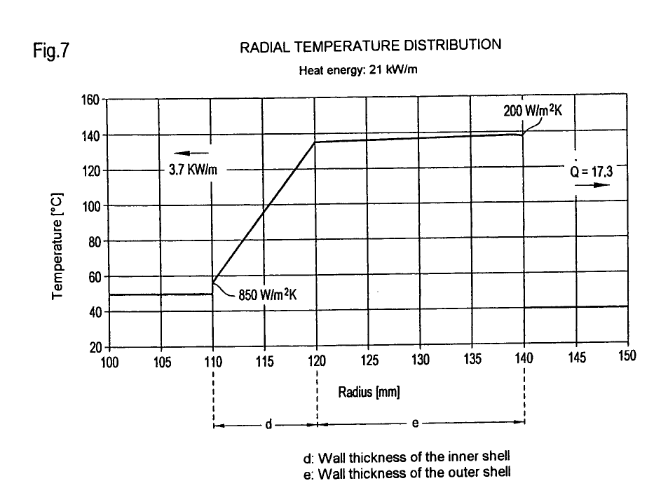

FIGS. 3, 4, 5, 6, and 7 show various graphs relating to the radial temperature distribution over the double shell of the roll for different surface temperatures, different wall thicknesses of the thermally insulating inner shell and different heat energies. In this case, a thermally insulating inner shell made of PEEK was provided. As can be seen from these FIGS. 3 to 7, the losses toward the interior are limited to a minimum.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### List of Designations

10 Heatable roll
12 Supporting system
14 Roll shell
14′ Heatable outer shell
14″ Thermally insulating inner shell
16 Yoke fixed against rotation
18 Hydraulic supporting element
d Wall thickness of the inner shell
e Wall thickness of the outer shell
X Axial direction

1. A heatable roll for thermal treatment of material webs comprising:
a supporting system; and
a roll shell revolving around the supporting system,
wherein the roll shell comprises a heatable outer shell and a thermally insulating inner shell, and the thermally insulating inner shell is arranged between the outer shell and the supporting system.

2. The roll according to claim 1, wherein the outer shell is structured and arranged to be separately heatable from the supporting system, and the supporting system is structured and arranged to remain unheated when the outer shell is heated.

3. The roll according to claim 1 structured and arranged as a controlled deflection roll,
wherein the supporting system comprises a yoke which axially passes through the roll shell and is fixed against rotation, and a plurality of supporting elements which follow one another in an axial direction.

4. The roll according to claim 3, wherein the supporting elements are arranged to act directly on the thermally insulating inner shell.

5. The roll according to claim 1, wherein the thermally insulating inner shell comprises a temperature-resistant plastic.

6. The roll according to claim 5, wherein the thermally insulating inner shell comprises PEEK.

7. The roll according to claim 1, wherein one of the heatable outer shell and the thermally insulating inner shell are provided with one of a tribological functional layer and a polytetrafluoroethylene layer.

8. The roll according to claim 1 structured and arranged as a self-adjusting F roll.

9. The roll according to claim 1 structured and arranged as a concentrically guided K roll.

10. The roll according to claim 1, wherein the thermally insulating inner shell is structured and arranged to be simultaneously used as a seal with respect to a guide mounting.

11. The roll according to claim 1, said roll shell being structured to have a clearance between the heatable outer shell and the thermally insulating inner shell when unheated and when supporting elements of the support system are not activated.

12. The roll according to claim 11, wherein the clearance is reduced during operation by at least one of thermal expansion of the thermally insulating inner shell and internal pressure.

13. The roll according to claim 1, wherein the thermally insulating inner shell is at least one of grooved and notched on an outer circumference.

14. The roll according to claim 1, wherein the heatable outer shell is at least one of grooved and notched on an inner circumference.

15. The roll according to claim 1, further comprising at least one of a grooved and notched region between the outer shell and the inner shell structured and arranged to receive blown air for cooling.

16. The roll according to claim 1, wherein the heatable outer shell comprises steel.

17. The roll according to claim 1, wherein the heatable outer shell is structured and arranged to be pushed onto the thermally insulating inner shell.

18. The roll according to claim 1, wherein the outer shell is heatable from the outside.

19. The roll according to claim 1, wherein the outer shell inductively heatable.

20. The roll according to claim 19 structured and arranged as an F roll, wherein an induction loop can be moved with a slotted F guide.

21. The roll according to claim 1, wherein the thermally insulating inner shell is thinner than the heatable outer shell.

22. The roll according to claim 1, wherein the thickness of the thermally insulating inner shell ranges from about 8 to about 15 mm.

23. The roll according to claim 1, wherein the thermally insulating inner shell has an average thickness of about 10 mm.

24. The roll according to claim 1, wherein the heatable outer shell is configured with one of a rubber covering and a plastic cover.

25. The roll according to claim 1, further comprising:
a cantilever structured and arranged to suspend the roll in a framing.

26. The roll according to claim 1, further comprising:
a bearing structured and arranged to expose the outer shell to be pulled off on an operating side.

27. The roll according to claim 1, wherein the heatable outer shell is adhesively bonded to the thermally insulating inner shell.

28. A method of producing a nonwoven material using the roll according to claim 1.

29. A method of consolidating a nonwoven material using the roll according to claim 1.

30. A method of embossing a nonwoven material using the roll according to claim 1.

31. The roll according to claim 1 in combination with a NipcoFlex calender,
wherein the roll is structured and arranged as an opposing roll.

32. A heatable roll for thermal treatment of material webs, comprising:
a thermally insulating inner shell arranged on a supporting system; and
a heatable outer shell arranged over the thermally insulating inner shell.

33. A process for thermal treatment of material webs, the roll having a supporting system and a roll shell, the roll shell composed of an outer shell and an insulating inner shell, the process comprising:
heating the outer shell of the roll shell, while the supporting system is thermally insulated from the heating.
